(19) United States
(12) Patent Application Publication
(10) Pub. No.: US 2012/0204982 A1
(43) Pub. Date: Aug. 16, 2012

(54) WELD-LINE ELIMINATION ON MOLDED PLASTIC PARTS

(75) Inventor: David M. Lyle, Chesterfield, MO (US)

(73) Assignee: NIDEC MOTOR CORPORATION, St. Louis, MO (US)

(21) Appl. No.: 13/027,993

(22) Filed: Feb. 15, 2011

(51) Int. Cl. F04D 29/42; B29C 45/14

(52) U.S. Cl. 137/565.01; 264/328.1; 264/328.12

(57) ABSTRACT

An injection molded pump housing defines an interior chamber operable to contain pressurized fluid and to permit selective drainage of fluid from the chamber. The pump housing includes a unitary housing body presenting an outer margin, with the body including a drain-port boss. The boss defines a hole that extends axially therethrough and communicates with the chamber to thereby permit fluid drainage, with at least part of the boss being disposed along the outer margin of the body. The body includes a protrusion that extends outwardly from the boss to define a portion of the outer margin of the body and thereby prevent a weld-line from being formed on the boss, such that the boss is devoid of a weld-line. A method of injection molding an element so as to eliminate weld-lines in a hole-defining portion of the outer margin of the element is also disclosed.

### BACKGROUND OF THE INVENTION

1. Field of the Invention

The present invention relates generally to injection molded parts. More specifically, the present invention concerns injection molded parts where structural portions are devoid of weld-lines that have been present in prior art molded parts.

2. Discussion of the Prior Art

Those of ordinary skill in the art will appreciate that injection molded parts are used in a variety of applications. In particular, various elements of dynamoelectric machine assemblies (e.g., pump housings, volutes, endshields, etc.) are often formed by injection molding of a suitable material, such as plastic or metal. Such injection molded elements often include bosses or other wall structure that defines a hole extending therethrough. Molding material around holes disposed near outer margins of the parts have resulted in weld-lines that are unsightly and that can cause failure of the element.

For example, many molded elements for use with a dynamoelectric machine include one or more bosses that form a portion of the outer margin of the element. Often, one of the bosses will define a hole extending therethrough. Traditionally, the hole is formed by placing a pin (or other obstruction) in the mold such that molten material flows around the pin to form the hole. As is generally known in the art, the amount of material used to mold the element (and thus the cost for the part) is kept to a minimum. It is therefore desirable to minimize the size of any hole-defining boss.

While known molded elements have been satisfactory in some respects, holes defined by bosses or other wall structure disposed along the outer margin of the element have also presented drawbacks. When these holes are formed, the molten material splits into a pair of flow fronts to flow around the pin, with the flow fronts then rejoining one another on the other side of the pin where the pair of flow fronts must fuse together. The fusing together of the flow fronts typically forms a weld-line or a knit-line, which is all the more noticeable when the hole is disposed adjacent the outer margin of the element and the weld-line is formed along the outer margin of the element.

The weld-lines formed by conventional molding practices not only create an unsightly condition on the surface of the molded element, but weld-lines can also impair the structural integrity of the element. As is generally known in the art, weld-lines become a line of weakness, where the element may be particularly prone to cracking or other breakage. For example, if the element is put under any lateral stress along the outer margin (e.g., by a screw or other fastener being received within the hole), then weakness of the molded material along the weld-line can quickly lead to premature cracking along the weld-line. As another example, if the molded element is configured to contain fluid, which may be in contact with the hole, then the fluid (especially if the fluid is under pressure) can work along the weld-line to propagate even very small cracks and leak out of the element.

### SUMMARY

The present invention provides an injection molded element that is devoid of weld-lines along the outer margin of any hole-defining wall structure. The present invention also provides a method of injection molding an element that eliminates problematic weld-lines from structural portions of the molded element. The apparatus and method of the present invention either moves the weld-line outside of critical structural portions of the element, or eliminates the weld-line altogether, relative to an area where a weld-line would otherwise appear in molded elements of the prior art. The present invention therefore not only provides a molded element that has a more uniform appearance, but also increased strength that can prevent leaks when the molded wall structure defines a hole that is configured to be in communication with a fluid.

According to one aspect of the present invention, an injection molded element is provided that is formed from an injection molding process in which material is injected through a mold gate into a mold cavity so as to flow generally in a flow direction to at least substantially fill the cavity. The injection molded element includes a unitary body that presents an outer margin defined at least generally by the cavity. The body includes wall structure that defines a hole formed during the molding process, with at least part of the wall structure extending along the outer margin of the body such that the hole is positioned adjacent the outer margin. The body also includes a protrusion that extends outwardly from the wall structure to define a portion of the outer margin that is spaced away from the wall structure relative to the flow direction such that the wall structure is devoid of a weld-line.

According to another aspect of the present invention, an injection molded pump housing is provided that defines an interior chamber operable to contain pressurized fluid and is configured to permit selective drainage of fluid from the chamber. The pump housing includes a unitary housing body that presents an outer margin. The housing body includes a drain-port boss. The boss defines a hole that extends axially therethrough and communicates with the interior chamber to thereby permit fluid drainage. At least part of the boss is disposed along the outer margin of the housing body. The housing body also includes a protrusion that extends outwardly from the boss to define a portion of the outer margin of the housing body and thereby prevent a weld-line from being formed on the boss.

Another aspect of the present invention concerns a method of injection molding an element so as to eliminate weld-lines in a hole-defining portion of the outer margin of the element. The injection molding method includes injecting material through a gate into a mold cavity that defines a unitary body, wherein the body presents an outer margin, and flowing the material around a pin spaced from the gate in the material flow direction, wherein the pin forms a hole within the body adjacent the outer margin. The flowing step includes the step of splitting the material flow into a pair of flow fronts as the material moves around the pin, with at least one of the flow fronts defining a portion of the outer margin. The injection molding method also includes further flowing the material beyond the pin and into a protrusion cavity disposed distally from the pin relative the material flow direction. The further flow step includes the step of rejoining the flow fronts within the protrusion cavity.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is fragmentary, isometric view of a pump assembly including a prior art molded pump housing element, shown with drain-port bosses being capped with drain plugs and including weld-lines;

FIG. 2 is an isometric view of the prior art molded pump housing element of FIG. 1, shown with the drain plugs removed;

FIG. 3 is an isometric view of a pump assembly including a molded pump housing element constructed in accordance with the principles of a preferred embodiment of the present invention, shown with drain-port bosses capped with drain plugs and including protrusions that each extend outwardly from the respective bosses such that the bosses are devoid of weld-lines;

FIG. 4 is an isometric view of the molded pump housing element of FIG. 3, shown with the drain plugs removed and depicting in greater detail the protrusions extending outwardly from the threaded drain-port bosses;

FIG. 5 is an isometric view of the molded pump housing element of FIGS. 3 and 4, shown from the opposite vantage point relative to FIG. 4, depicting in detail an interior chamber of the element communicating with holes in the drain-port bosses;

FIG. 6 is an elevation view of the molded pump housing element of FIGS. 3-5, depicting in detail the relative sizes of the drain-port bosses and the corresponding protrusions extending outwardly therefrom; and

FIG. 7 is a side sectional view of the molded pump housing element of FIGS. 3-6, taken along the line 7-7 of FIG. 6, depicting in detail the threaded hole extending through the drain-port boss and the structure of the corresponding protrusion extending outwardly therefrom.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

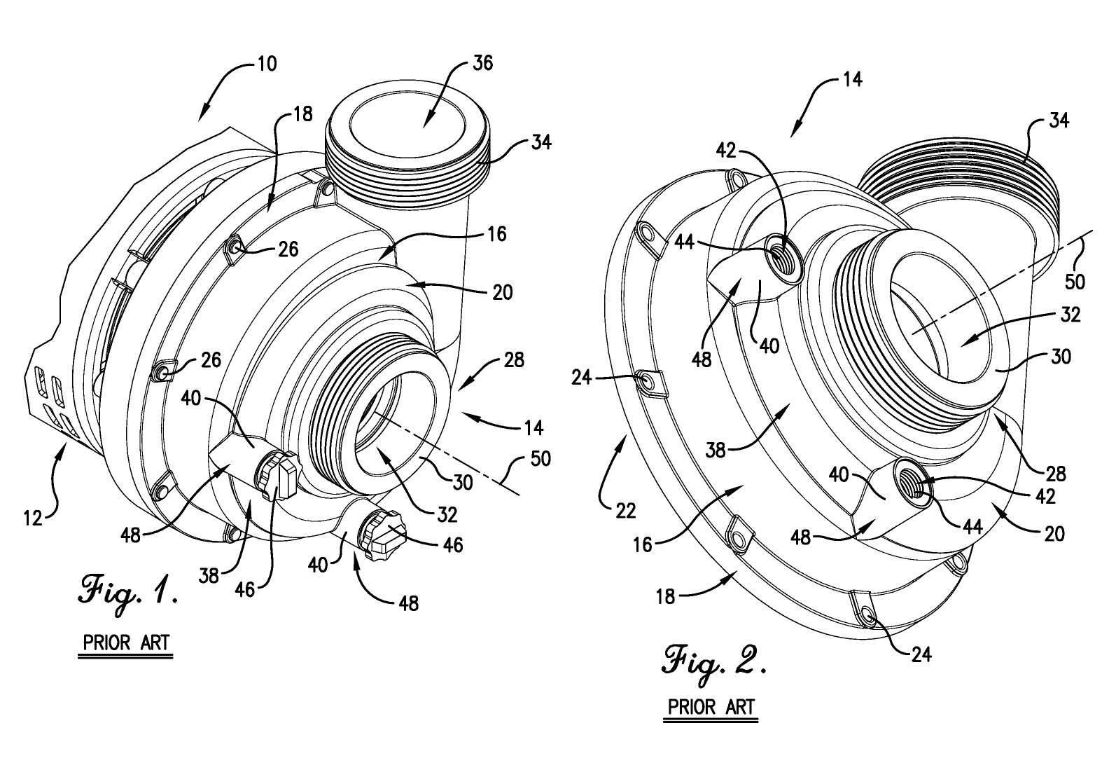

With initial reference to FIGS. 1 and 2, a prior art pump assembly 10 is depicted that broadly includes an electric motor assembly 12 and a conventional pump housing element 14. The electric motor assembly 12 drives an impeller (not shown) to pressurize a fluid (preferably a liquid, such as water for a pool or sauna), as will be readily understood by one of ordinary skill in the art. The pump housing element 14 includes a traditional injection molded unitary body 16 that broadly includes a flange section 18 and a generally annular volute section 20, with the volute section 20 extending generally away from the flange section 18 to define an interior chamber 22.

With particular reference to FIG. 2, the flange section 18 defines a plurality of circular openings 24 extending axially therethrough. Turning back to FIG. 1, a corresponding plurality of fasteners 26 are received within the openings 24 to secure the body 16 of the pump housing element 14 to the electric motor assembly 12, as is generally conventional in the art. As will be readily appreciated by one of ordinary skill in the art, the impeller (not shown) is at least partially disposed within the interior chamber 22.

The volute section 20 of the body 16 generally converges radially inwardly from the flange section 18 to an axial end margin 28. At the axial end margin 28, a first externally threaded circular wall structure 30 defines an axial inlet opening 32. As will be readily understood by one of ordinary skill in the art upon review of this disclosure, a second externally threaded circular wall structure 34 defines a generally radial outlet opening 36 configured to transport pumped fluid out of the pump assembly 10.

The conventional body 16 presents an outer margin 38. In the embodiment shown, the conventional body 16 also includes a pair of cylindrical drain-port bosses 40. Looking briefly to FIG. 2, each of the drain-port bosses 40 defines a respective drain hole 42 extending axially therethrough to provide fluid communication from within the interior chamber 22 to the outside environment. As is generally known in the art, the drain holes 42 allow fluid within the pump assembly 10 to be drained out of the pump assembly 10, such as for maintenance operations, winterizing, or the like.

In the depicted embodiment, at least a part of each drain-port boss 40 extends along the outer margin 38 of the body 16, such that the drain holes 42 are disposed adjacent the outer margin 38 of the body 16. With continued reference to FIG. 2, the illustrated drain holes 42 are defined by internally threaded wall structure 44 that is molded as part of the unitary body 16.

Returning now to FIG. 1, a threaded drain plug 46 is shown to be threadably received within each of the drain holes 42 to prevent drainage of fluid within the interior chamber 22 during ordinary operation of the pump assembly 10. As identified in both FIGS. 1 and 2, each of the drain-port bosses 40 also includes a molded material weld-line. The weld-line is typically formed along a radially outermost margin of the boss 40, often extends generally axially therealong (although the weld-line may form along alternative paths), and is identified generally herein with numeral 48.

As will be appreciated by one of ordinary skill in the art, the weld-lines 48 are the result of forming the conventional unitary body 16 by an injection molding process. For instance, the illustrated unitary body 16 is formed from a suitable material (e.g., a synthetic resin material such as plastic), which is injected through a gate into a mold cavity to form the unitary body 16. In more detail, the illustrated body 16 is formed by injecting material through a single gate disposed generally centrally at the axial margin 28, such that the material flows generally radially outwardly relative to a central axis 50 of the body 16. In this way, the material flows outwardly toward the outer margin 38 to define the shape of the body 16.

As is generally known in the art, the threaded wall structure 44 and the holes 42 are formed by incorporating pins into the mold, such that the material flows around the pins to leave voids for the holes 42. To form the threaded wall structure 44, threaded pins (not shown) are incorporated, with the pins being threadably removed from the body 16 after the material has solidified. As the material flows around each of the pins (whether threaded or not), the flow is split into a pair of flow fronts, which then rejoin one another on the other side of each of the respective pins where the pair of flow fronts must fuse together.

In forming the body 16 depicted in FIGS. 1 and 2, the material flows generally radially outwardly from a central gate toward the outer margin 38. Because the drain-port bosses 40 extend along the outer margin 38, when the material flow fronts that flow around the pins rejoin and fuse together, the material fusing takes place at a location along the outer margin 38 disposed radially outwardly from the central axis 50 of the body. Therefore, the weld-lines 48 form on the drain-port bosses 40 to create an unsightly condition on the outer margin 38 of the molded body 16.

Not only are the weld-lines 48 aesthetically unpleasing to a potential purchaser of the molded housing 14, but the location of the weld-lines 48 on the structural wall portions of the drain-port bosses 40 can produce a line of weakness between the drain holes 42 and the outside environment. Since the interior chamber 22 of the body 16 contains a pressurized fluid during pumping operations, the fluid has a tendency to work along any such lines of weakness to propagate even small cracks and leak out of the molded body 16 through the weld-lines 48.

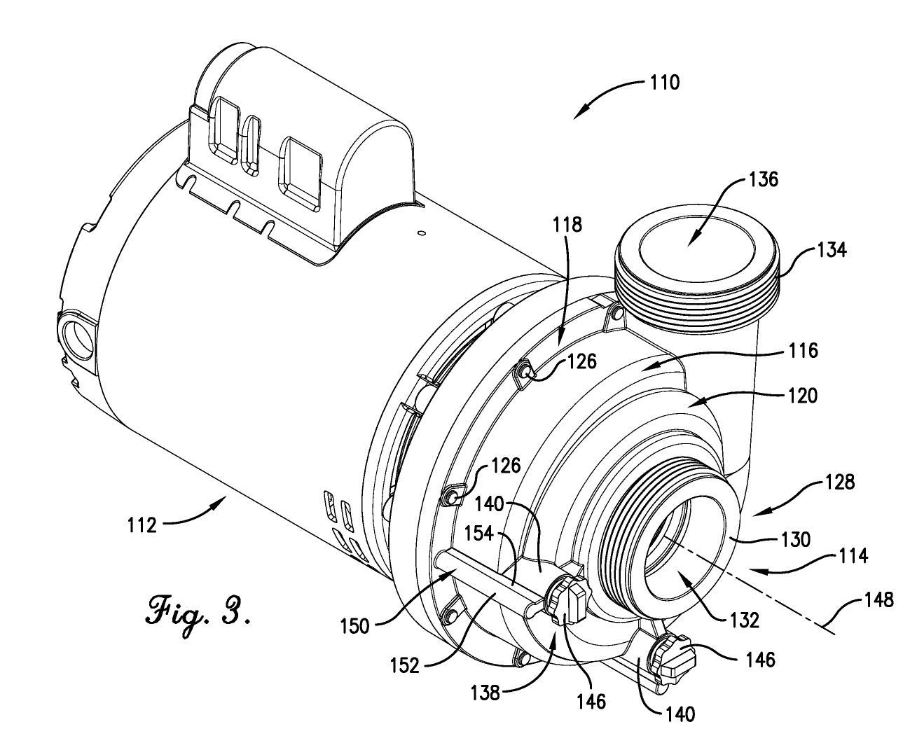

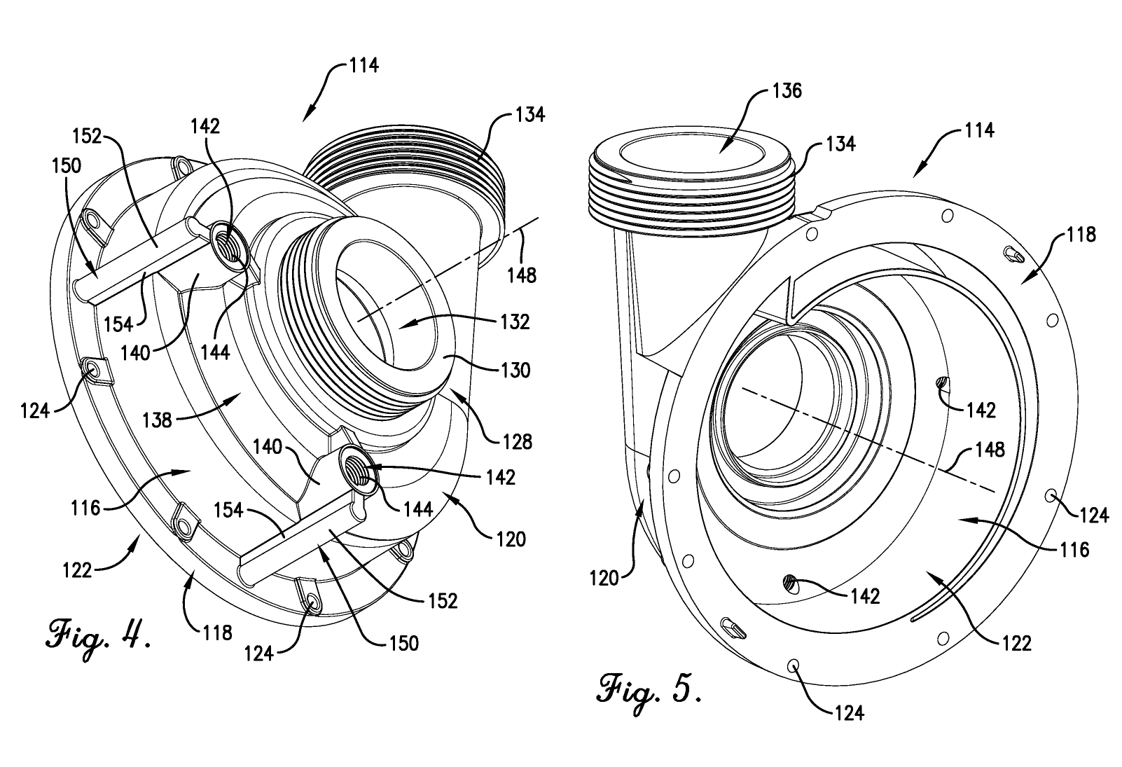

With attention now to FIGS. 3-7, a pump assembly 110 is depicted that broadly includes an electric motor assembly 112 and an injection molded element in the form of a pump housing 114 constructed in accordance with a preferred embodiment of the present invention. It is initially noted that the pump housing element 114 is illustrated and described herein by way of example only, and that other injection molded elements (e.g., other elements for dynamoelectric machine assemblies, such as motor endshields and the like) may be alternatively constructed in accordance with the teachings of the present invention.

The injection molded pump housing element 114 is formed from an injection molding process in which a suitable material (e.g., a synthetic plastic resin such as a plastic, or a metal such as aluminum) is injected through a mold gate into a mold cavity so as to flow generally in a flow direction to at least substantially fill the cavity, as described in further detail below. In the illustrated embodiment, it is noted that the flow direction is generally radially outwardly from a single central gate, although other flow patterns for alternatively shaped bodies (not shown) may of course be incorporated without departing from the teachings of the present invention.

The electric motor assembly 112 depicted in FIG. 3 is generally conventional, as will be readily understood by one of ordinary skill in the art, and need not be described in further detail here. The electric motor assembly 112 drives an impeller (not shown) to pressurize a fluid (preferably a liquid, such as water for a pool or sauna), as will be readily understood by one of ordinary skill in the art. The pump housing element 114 includes an injection molded unitary body 116 that broadly includes a flange section 118 and a generally annular volute section 120, with the volute section 120 extending generally away from the flange section 118 to define an interior chamber 122.

With particular reference to FIGS. 4-6, the flange section 118 defines a plurality of circular openings 124 extending axially therethrough. Turning back to FIG. 3, a corresponding plurality of fasteners 126 are received within the openings 124 to secure the body 116 of the pump housing element 114 to the electric motor assembly 112. As will be readily appreciated by one of ordinary skill in the art, the impeller (not shown) is at least partially disposed within the interior chamber 122.

The volute section 120 of the body 116 generally converges radially inwardly from the flange section 118 to an axial end margin 128. At the axial end margin 128, a first externally threaded circular wall structure 130 defines an axial inlet opening 132. As will be readily understood by one of ordinary skill in the art upon review of this disclosure, a second externally threaded circular wall structure 134 defines a generally radial outlet opening 136 configured to transport pump fluid out of the pump assembly 110.

The unitary body 116 of the present invention presents an outer margin 138 that is defined at least generally by the mold cavity. In the illustrated embodiment, the body 116 includes wall structure in the form of a generally cylindrical drain-port boss 140 that defines a drain hole 142 formed during the molding process. It is specifically noted that alternative embodiments of the present invention may include wall structure other than in the form of a boss and that the hole defined thereby may serve another purpose (e.g., a mounting hole in an endshield), without departing from the teachings of the present invention. It is further noted that the term “boss” as used herein is intended to cover any projection or protuberance (frequently, although not necessarily, in the general form of a cylinder) of material that extends beyond a hole.

In the embodiment shown in FIGS. 3-7, the unitary body 116 includes a pair of the drain-port bosses 140, although other numbers or types of hole-defining wall structure would remain firmly within the ambit of the present invention, as discussed above. Looking briefly to FIGS. 4-6, each of the drain-port bosses 140 defines a respective one of the drain holes 142 that extends axially therethrough to provide fluid communication from within the interior chamber 122 to the outside environment. The drain holes 142 allow fluid within the pump assembly 110 to be drained out of the pump assembly 110, such as for maintenance operations, winterizing, or the like.

In the depicted embodiment, at least a part of each drain-port boss 140 extends along the outer margin 138 of the body 116, such that the drain holes 142 are disposed adjacent the outer margin 138 of the body 116. With continued reference to FIGS. 4-7, the illustrated drain holes 142 are defined by internally threaded wall structure 144 that is molded as part of the unitary body 116.

Returning briefly to FIG. 3, a threaded drain plug 146 is shown to be threadably received within each of the drain holes 142 to prevent drainage of fluid within the interior chamber 122 during ordinary operation of the pump assembly 110. It is noted that other types of drain plugs (non-threaded; not shown) may be alternatively used, and it is noted further that alternative molded elements may include holes for purposes other than drainage, such that non-threaded holes are clearly contemplated and remain within the ambit of the present invention.

With attention particularly to FIGS. 4, 6, and 7, the unitary body 116 of the present invention further includes a protrusion 150 that extends generally outwardly from the depicted drain-port boss 140 (or other hole-defining wall structure). The protrusion 150 defines a portion of the outer margin 138 that is spaced away from the boss 140 relative to the material flow direction, such that the boss 140 is devoid of any weld-line therein.

In the illustrated embodiment, the depicted protrusion 150 broadly includes an enlarged end portion 152 and a necked rib portion 154. The enlarged end portion 152 is spaced generally radially outwardly from the boss 140, with the rib portion 154 interconnecting the end portion 152 and the boss 140.

The protrusion 150 extends axially coextensively with the boss 140, relative to the central axis 148 of the body 116. In the illustrated embodiment, the protrusion 150 projects axially beyond the boss 140, with the enlarged end portion 152 and the rib portion 154 being axially coextensive with one another.

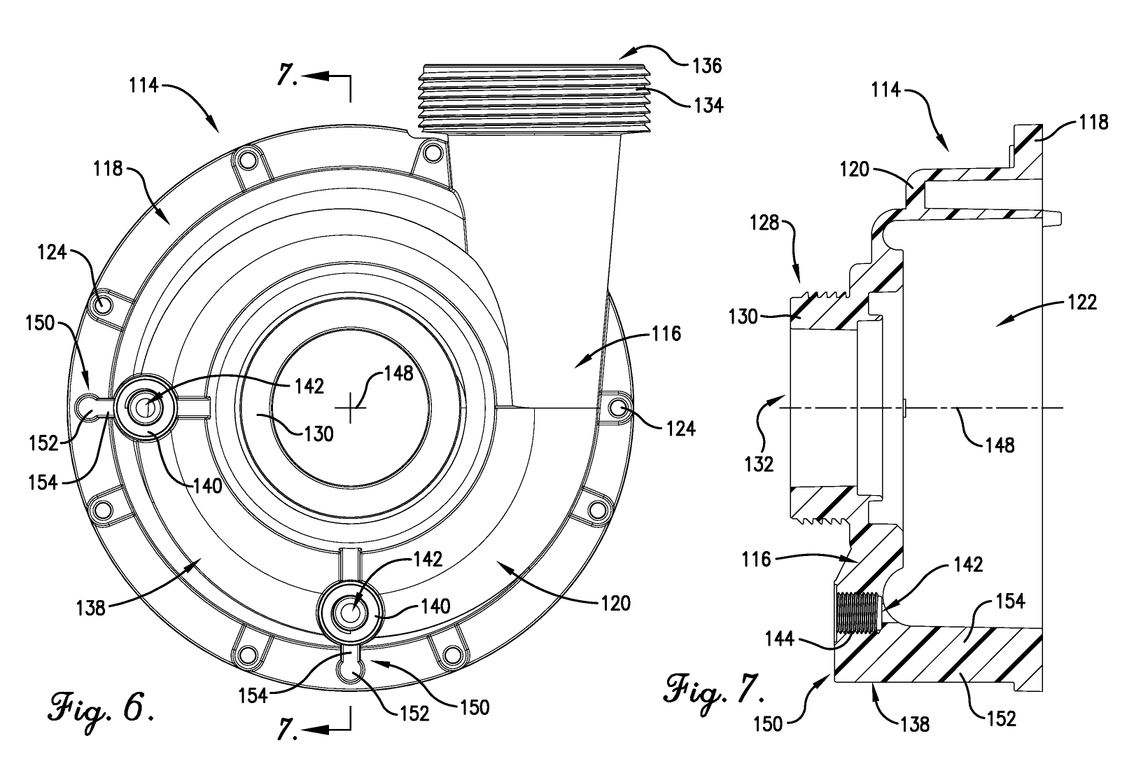

With particular reference to FIG. 6, the boss 140 presents a maximum lateral boss dimension measured in a direction that is at least substantially perpendicular to the central axis 148. The protrusion 150 presents a maximum lateral protrusion dimension that is less than the boss dimension. In more detail with respect to the illustrated embodiment, the rib portion 154 presents a maximum lateral rib dimension, with the enlarged end portion 152 presenting a maximum lateral end dimension that is greater than the rib dimension. As depicted, the maximum lateral end dimension is the maximum lateral protrusion dimension.

In one embodiment, the protrusion 150 is solid (i.e., devoid of any hole being defined therein). Most preferably, the protrusion 150 is spaced from the hole 142. As shown in FIG. 6 of the illustrated embodiment, the boss 140 and the enlarged end portion 152 each present a generally circular shape. As shown in FIG. 7 of the illustrated embodiment, the unitary body 116 presents a non-uniform wall thickness dimension. Other shapes and sizes are naturally contemplated by the present invention.

From the above description, a method of injection molding the unitary body 116 of the pump housing element 114 should be readily apparent to one of ordinary skill in the art and, therefore, will be described here only briefly. The illustrated unitary body 116 is formed from a suitable material (e.g., a synthetic resin material such as plastic), which is injected into a mold cavity that defines the unitary body 116, wherein the body 116 presents the outer margin 138. In more detail, the illustrated body 116 is preferably formed by injecting material from a single gate disposed generally centrally at the axial margin 128, such that the material flows generally radially outwardly relative to the central axis 148 of the body 116. In this way, the material flows outwardly toward the outer margin 138 to define the shape of the body 116.

Next, the threaded wall structure 144 and the holes 142 are formed by incorporating pins into the mold, such that the material is flowed around the pins, which are spaced from the gates in the material flow direction, wherein the pins leave voids for the holes 142 within the body 116 adjacent the outer margin 138. To form the threaded wall structure 144, threaded pins (not shown) are incorporated, with the pins being threadably removed from the body 116 after the material has solidified. As the material flows around each of the pins (whether threaded or not), the material flow is split into a pair of flow fronts, with at least one of the flow fronts defining a portion of the outer margin 138.

The material is further flowed beyond the pins and into respective protrusion cavities, which are disposed distally from the pins relative to the material flow direction. The corresponding flow fronts then rejoin one another on the other side of each of the pins within the respective protrusion cavities, where the pair of flow fronts must fuse together.

To form the unitary body 116 of the illustrated embodiment, the splitting of the material flow into a pair of flow fronts includes filling a boss cavity with the flow fronts, with the threaded pin being generally centrally located within the boss cavity. Furthermore, the rejoining of the flow fronts within the protrusion cavity includes converging the material flow within a narrowed rib portion of the protrusion cavity to form the rib 154, and extending material flow within an enlarged end portion of the protrusion cavity to form the enlarged end 152, as described above. It is believed that this arrangement helps ensure that the flow fronts are rejoined in the protrusion cavity rather than within the boss cavity.

In forming the unitary body 116 as depicted in FIGS. 3-7, the material flows generally radially outwardly from a central gate toward the outer margin 138. Because only a portion of the drain-port bosses 140 extends along the outer margin 138, when the material flow fronts flow around the pins to rejoin and fuse together within the protrusion cavity, the material fusing takes place at a location spaced from the boss cavity. In more detail, the material fusing takes place at a location spaced radially outwardly from the central axis 148 of the body relative to the boss cavity. Therefore, any conventional welds lines, which may otherwise have formed on the drain-port bosses 140, are eliminated from the structure of the drain-port bosses 140.

Thus, by ensuring that the structure defining the drain-port bosses 140 is devoid of any weld-lines, the risks of fluid leakage through the drain-port bosses 140 (or breakage along lines of weakness, unsightly discoloration, or other undesirable consequences of weld-lines), are greatly reduced, if not entirely eliminated.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and access the reasonably fair scope of the present invention as pertains to any apparatus not materially departing from but outside the literal scope of the invention set forth in the following claims.

What is claimed is:

1. An injection molded element formed from an injection molding process in which material is injected through a mold gate into a mold cavity so as to flow generally in a flow direction to at least substantially fill the cavity, said injection molded element comprising:
a unitary body presenting an outer margin defined at least generally by the cavity,
said body including wall structure defining a hole formed during the molding process, with at least part of the wall structure extending along the outer margin of the body such that the hole is positioned adjacent the outer margin,
said body including a protrusion extending outwardly from the wall structure to define a portion of the outer margin that is spaced away from the wall structure relative to the flow direction such that the wall structure is devoid of a weld-line.

2. The injection molded element as claimed in claim 1,
said at least part of the wall structure including an outwardly projecting boss,
said hole extending axially through the boss, with the boss presenting a maximum lateral boss dimension measured in a direction that is at least substantially perpendicular to the axis,
said protrusion presenting a maximum lateral protrusion dimension that is less than the boss dimension.

3. The injection molded element as claimed in claim 2,
said protrusion being axially coextensive with the boss.

4. The injection molded element as claimed in claim 3,
said protrusion projecting axially beyond the boss.

5. The injection molded element as claimed in claim 2,
said protrusion including an enlarged end portion and a necked rib portion,
said end portion being spaced from the boss,
said rib portion interconnecting the boss and the end portion.

6. The injection molded element as claimed in claim 5,
said rib portion presenting a maximum lateral rib dimension,
said end portion presenting a maximum lateral end dimension that is greater than the rib dimension.

7. The injection molded element as claimed in claim 6,
said maximum lateral end dimension being the maximum lateral protrusion dimension.

8. The injection molded element as claimed in claim 6,
said rib portion being axially coextensive with the end portion and the boss.

9. The injection molded element as claimed in claim 6,
said boss and end portion each presenting a generally circular shape.

10. The injection molded element as claimed in claim 2,
said boss including molded internal threads.

11. The injection molded element as claimed in claim 1,
said protrusion being solid.

12. The injection molded element as claimed in claim 1,
said body presenting a non-uniform wall thickness dimension.

13. The injection molded element as claimed in claim 1,
said body defining an interior fluid-containing chamber defined at least in part by the wall structure,
said protrusion being spaced from the chamber.

14. The injection molded element as claimed in claim 13,
said at least part of the wall structure including an outwardly projecting boss,
said hole extending axially through the boss, with the boss presenting a maximum lateral boss dimension measured in a direction that is at least substantially perpendicular to the axis,
said protrusion presenting a maximum lateral protrusion dimension that is less than the boss dimension.

15. The injection molded element as claimed in claim 14,
said protrusion including an enlarged end portion and a necked rib portion,
said end portion being spaced from the boss,
said rib portion interconnecting the boss and the end portion.

16. An injection molded pump housing defining an interior chamber operable to contain pressurized fluid and being configured to permit selective drainage of fluid from the chamber, said pump housing comprising:
a unitary housing body presenting an outer margin,
said housing body including a drain-port boss,
said boss defining a hole that extends axially therethrough and communicates with the interior chamber to thereby permit fluid drainage,
at least part of said boss being disposed along the outer margin of the housing body,
said housing body including a protrusion that extends outwardly from the boss to define a portion of the outer margin of the housing body and thereby prevent a weld-line from being formed on the boss.

17. The pump housing as claimed in claim 16,
said housing body extending generally radially outwardly from and generally axially along a central axis,
said housing body including a generally annular volute section,
said boss being spaced radially from the central axis and disposed adjacent the volute section,
said protrusion projecting radially outwardly from the boss.

18. The pump housing as claimed in claim 17,
said boss presenting a maximum lateral boss dimension measured in a direction that is at least substantially perpendicular to the central axis,
said protrusion presenting a maximum lateral protrusion dimension that is less than the boss dimension.

19. The pump housing as claimed in claim 18,
said protrusion being axially coextensive with the boss.

20. The pump housing as claimed in claim 19,
said protrusion projecting axially beyond the boss.

21. The pump housing as claimed in claim 18,
said protrusion including an enlarged end portion and a necked rib portion,
said end portion being spaced from the boss,
said rib portion interconnecting the boss and the end portion.

22. The pump housing as claimed in claim 21,
said rib portion presenting a maximum lateral rib dimension,
said end portion presenting a maximum lateral end dimension that is greater than the rib dimension.

23. The pump housing as claimed in claim 22,
said maximum lateral end dimension being the maximum lateral protrusion dimension.

24. The pump housing as claimed in claim 22,
said rib portion being axially coextensive with the end portion and the boss.

25. The pump housing as claimed in claim 22,
said boss and end portion each presenting a generally circular shape.

26. The pump housing as claimed in claim 17,
said housing body including a pair of the bosses, with a corresponding protrusion being disposed radially outwardly from each of the bosses,
said pair of bosses and corresponding protrusions being spaced circumferentially away from one another.

27. The pump housing as claimed in claim 16,
said boss including molded internal threads such that the hole is configured to threadably receive a drain plug therein.

28. The pump housing as claimed in claim 16,
said protrusion being solid.

29. The pump housing as claimed in claim 16,
said housing body presenting a non-uniform wall thickness dimension.

30. A method of injection molding an element so as to eliminate weld-lines in a hole-defining portion of the outer margin of the element, said injection molding method comprising the steps of:
(a) injecting material through a gate into a mold cavity that defines a unitary body, wherein the body presents an outer margin;
(b) flowing the material around a pin spaced from the gate in the material flow direction, wherein the pin forms a hole within the body adjacent the outer margin,
step (b) including the step of splitting the material flow into a pair of flow fronts as the material moves around the pin, with at least one of the flow fronts defining a portion of the outer margin; and
(c) further flowing the material beyond the pin and into a protrusion cavity disposed distally from the pin relative the material flow direction,
step (c) including the step of rejoining the flow fronts within the protrusion cavity.

31. The injection molding method as claimed in claim 30,
step (c) being performed after step (b).

32. The injection molding method as claimed in claim 31,
step (b) including the step of filling a boss cavity with the flow fronts, with the pin being generally centrally located within the boss cavity.

33. The injection molding method as claimed in claim 32,
step (c) including the step of converging the material flow within a narrowed rib portion of the protrusion cavity and then expanding the material flow within an enlarged end portion of the protrusion cavity.

34. The injection molding method as claimed in claim 30,
said pin being threaded; and
(d) removing the pin from the mold cavity after the material is injected,
step (d) including the step of rotating the pin as it is removed.

35. The injection molding method as claimed in claim 31,
step (a) including the step of introducing the material into the mold from only a single central gate,
steps (b) and (c) including the step of flowing the material in a generally radial outward flow direction.

36. The injection molding method as claimed in claim 30,
step (c) including the step of filling the protrusion cavity completely so that the protrusion is solid.
